(19) United States
(12) Patent Application Publication
(10) Pub. No.: US 2011/0295529 A1
(43) Pub. Date: Dec. 1, 2011

(54) CONTROL OF PROTECTION RELAY

(75) Inventors: Kari VANHALA, Vahakyro (FI); Petri Koivula, Laihia (FI)

(73) Assignee: ABB Technology AG, Zurich (CH)

(21) Appl. No.: 13/169,439

(22) Filed: Jun. 27, 2011

Related U.S. Application Data
(63) Continuation of application No. PCT/FI2009/050006, filed on Jan. 7, 2009.

(51) Int. Cl. G06F 19/00

(52) U.S. Cl. 702/57

(57) ABSTRACT

A protection relay and a method for controlling a protection relay are provided. An input parameter value is measured for the protection relay, and a calculation parameter value is determined based on an inverse definite minimum time curve defining a relationship between the input parameter value and a predetermined threshold value of the input parameter, wherein the calculation parameter values are divided into two or more zones and restricted with zone-specific dividers. The restricted calculation parameter value is added to a cumulative sum of the calculation parameter, where the cumulative sum of the calculation parameter is usable in a calculation equation for determining an operate and/or reset condition of the protection relay.

### RELATED APPLICATION

This application claims priority as a continuation application under 35 U.S.C. §120 to PCT/FI 2009/050006 filed as an International Application on Jan. 7, 2009 designating the U.S., the entire content of which is hereby incorporated by reference in its entirety

### FIELD

The present disclosure relates to a protection relay and to a method of controlling a protection relay.

### BACKGROUND INFORMATION

Relays are used in the protection of electric networks and devices, for example. Relay protection functions may be implemented as constant-time functions, where the operation time is independent of the value of an input signal magnitude, such as current, voltage, frequency, temperature, power, energy, etc. To start the protection function, it is sufficient that the magnitude exceeds a set start value. Alternatively, relay protection functions may be inverse-time dependent, when the operation time is inversely dependent on the momentary magnitude of the input measure.

The supplier of the relay may define a set of usable calculation models or curves. For some signals, for example current, there are international standards, where some of these operation curves are defined. The customer may then select a relay using one of the pre-defined calculation modes that best suit his purpose. However, lately the demands of providing the customers with a possibility to define their own calculation models have increased. This will pose extra requirements to protection relays, especially those using limited calculation capacity and settings.

The institute of Electrical and Electronics Engineers (IEEE) Standard C37.112-1996 defines an integral equation for microprocessor relays that ensures coordination not only in the case of constant current input but for any current condition of varying magnitude. Presently, there are no standards for other signal magnitudes than current, but several manufacturers are proposing that similar parameter-based curves also be used for other signals. Consequently, a generalized inverse definite minimum time (IDMT) curve equation representing operate-time may be given that can be applied for all signal types. The operate-time alias trip-time here refers to a time from the startup to the moment of tripping. Generally, the relationship between operate-time and signal magnitude can be expressed as in equation (1):

$$t ( M ) = \frac{k * a}{{( b * \pm ( \frac{M}{M ≺} - e ) - c )}^{p} - f} + d , \qquad ( 1 )$$

where:

t is the operate (trip)—time in seconds,

k is a settable time multiplier (time dial) of the function (note that k can also be thought to be included into d here),

a, b, c d, e, f and p are curve parameters,

M is a measured magnitude, and

M [symbol] is a set start magnitude, start value. It can be > (over) or < (under) the function limitation.

Standard equations and most of the other presented curve equations for different types of signals can be derived from this generalized equation. For standardized curves, the only variable quantity is M and all other parameters have been given. Recently, a multiplicity of relays has been developed to which the customer can himself give the equation parameters.

Furthermore, some standards propose that it is possible for the customer to give a number of IDMT curve points to define a specified time curve. Additionally, there exist specified curve tools that primarily can be used for evaluation and secondarily for downloading customer specified curve parameters or look-up-tables (LUT) presenting all curve points to a relay. IDMT curve monotonicity may be required in curve evaluation, or if this is not required, then there is a selectivity schema between protection stages that deal with curve discontinuities.

As an example, we may consider a sub-class over-voltage equation deduced from equation (1) (=>f=0, e=1, M>, ±=+), where the time to trip is thus inversely dependent on how much the input voltage exceeds the startup voltage. If the excess is great, the time to trip will be short. This is illustrated by a simplified equation (2) showing a basic form of an inverse over-voltage equation when M>1 in equation (1).

$$t = \frac{k * a}{{( b \frac{U - U >}{U >} - c )}^{p}} + d , \qquad ( 2 )$$

where:

t is the operate (trip)-time in seconds,

k is a settable time multiplier,

U is a measured voltage,

U> is a settable start voltage, and

a, b, c, d, p are settable curve parameters.

It can be seen from equations (1) and (2) that the calculated operate-time range from unity to the highest M depends most effectively on the value of parameter p. In other words, parameter p mainly defines the steepness of the operate-time curve as a function of the signal magnitude ratio.

There are many ways to implement the operate-time calculation based on given equation (1). One way is to calculate the value t from the equation and use its reciprocal for an integral sum component. This type of calculation is computationally very prone to errors when the already cumulated sum is large and when adding a small integral sum component to it, especially in the case of a floating-point processor. Generally, large value divisions are to be avoided in a fixed-point processor environment, which also makes this first type rather a poor way to make a calculation in a fixed-point system.

A second and better method is, for example, to calculate an equation denominator or some other part of the equation beforehand to a so-called look-up-table (LUT) for different values of M and by this way avoid division in the execution phase. In this case, the manufacturer has to decide beforehand the step between the different M values in LUT and, for better accuracy in calculation, the step grip has to be tightened or some interpolation between the LUT steps has to be implemented in the execution phase if a zero-order hold (ZOH, i.e., value is frozen until next change) is not sufficient for signal ratio values between the steps.

A third way is to calculate a solution t(M) for M>1 so that there will be no divisions during the execution phase. One may compare two rather large numbers and this guarantees calculation accuracy for both floating and fixed-point solutions. As a result, this approach gives the most optimal operation performance for accuracy. If a reset operation also has to be supported in this approach, then it is even more challenging to combine both the operate (M>1) and reset (M<1) equations together and estimate operate-time without any divisions during execution.

FIG. 1 shows an example of operation curves of a protection relay. As an example, we may consider that the measured parameter is voltage and the curve is an over-voltage function representation. The y axis shows the operate-time, and the x axis shows a relationship between a measured voltage U and a voltage threshold level U> that is defined as an over-voltage ratio. Three curves A, B and C, are illustrated in FIG. 1. For example, for curve A, the operate-time is 1 second for a constant over-voltage ratio of 1.75. As shown, the curves have different steepnesses such that curve C is the steepest one, and A is less steep.

In a processor of a relay, there may be provided a calculation algorithm, which calculates the operate-time. In practice, the over-voltage ratio is not constant as shown in FIG. 1, and the calculation may thus take into account the fact that the over-voltage level may fluctuate. For example, at a first moment of time, the over-voltage ratio may be 1.5, whereas at the second moment of time it may be 2.5. Of course, a dramatic change in signal variation between successive task cycles does not exist but it can happen for longer time period. The momentary calculation results may be cumulated in a calculation equation, and different over-voltages have a different impact on the calculated operate-time. The over-voltage level and the “time-to-tripping” may be calculated once in a relay operate cycle (task time), which may be 2.5 ms, for example, but varies a lot between different relays. Also, there can be several function operate cycles in the same relay, where the same functionality can be instanced to different task cycles.

As the calculation of the time-to-tripping may be relatively complex and time consuming, some of the variables may be stored beforehand in a look-up table (LUT). For example, the range of over-voltage ratio of 1 to 5 may be divided into intervals with fixed or varying LUT steps, and each index in the interval may be associated with a temporary calculation parameter (LUT) value. The temporary calculation parameter values may be cumulated to a sum calculation parameter value, which may be used in the calculation of the operate-time. As noted above, zero-order hold can be used for ratios between exact LUT points, but some kind of interpolation can also be used when defining the LUT value between pre-defined ratios.

The steeper the IDMT curve is, the wider value range the LUT values will be mapped in. This required value range width is referred to as curve dynamics herein. Furthermore, the larger the value to be stored to LUT, the larger the possibility of overflow during execution multiplication.

One way to implement the lookup table is to have a higher index correspond to a higher value in the lookup table. The original lookup table corresponding to curve C thus generally includes larger variation between values than the lookup tables of curves A and B. That is, the curve dynamics for C is larger. In the case of a fixed point processor, special attention needs to be made to controlling calculation operations so that they do not cause overflow situations. Curve C, mostly extending to greater values in the lookup table, is risky from the multiplication overflow point of view. It may be noted that user-specified curves may be even steeper than curve C, whereby the overflow risk is even bigger.

Steep IDMT curves can be difficult to implement because although the LUT value word length is limited, the operate-time accuracy requirements still have to be achieved. FIG. 1 highlights the problem with a simple monotonic but steep IDMT operate curve, where the curve parameters for curve C are k=15, a=480, b=32, p=3, c=0.5 and d=0.035. FIG. 1 shows that operate-times for signals 1<M<1.02 exceed 174 930 seconds. Furthermore, at M=1.1, operate-time is only 24.42 seconds and operate-time undershoots 40 ms for M>2.4. Note that equation parameter d=0.035 already restricts the shortest operate-time to at least 35 ms.

It is assumed that value 1/t(M) is either a value calculated during every execution cycle or a pre-calculated value fetched during the execution phase from the LUT. Because the operate-times during the whole signal ratio range need to be distinguished due to operate-time accuracy, a difference needs to be made between every signal ratio point.

Next, we can briefly study the reciprocal of the operate-time within the voltage ratio range, because this is the most straightforward way of implementing operate-time calculation even though it is not the most optimum, as already stated. As a result, the range [1/t(1.02) . . . 1/t(5.00)] corresponds to [1/2623907 . . . 1/0.035]=[3.811*10⁻⁷ . . . 28.5714], and these values are either calculated during the execution or pre-calculated to the LUT. For fixed-point systems, this range is scaled above unity so that at its simplest the scaled range will be [1 . . . (28.5714/3.811*10⁻⁷)≈74970874].

Because here log₂(74970874)≈26.16, there have to be at least 27 bits to implement the LUT values. In order to find out if it is possible to distinguish between two successive LUT values for the steepest curve part, it can be noted that the next LUT M value above 1.02 as a solution of inequality k*a./(b*(M−1)−c)^{p}+d≈1/(2*3.811*10⁻⁷) will give M≈1.0211371. The LUT step difference fragment bit length is log₂(0.0011371)≈−9.78 so that actually the LUT step is approximately 2⁻⁹. However, this approach with zero-order-hold approach results to 50% upper bound error for first LUT values, which cannot be approved.

Therefore, it can be deduced that the ratio between first LUT values cannot be a unity but it must be larger and, for example in a given situation, the first and last 1/t values for M≧1.02≦5.00 with LUT step 2⁻⁹ will be [1, 35, 172, 485, 1043, 1919, 3185, 4912, . . . , 67962937, 68011154, 68058952, 68106335, 68153307, 68199873], where the last calculated value is represented by log₂(68199873)=26.02 bits.

### SUMMARY

An exemplary embodiment of the present disclosure provides a protection relay which includes means for measuring an input parameter value for the protection relay, and means for determining at least one calculation parameter value based on an inverse definite minimum time curve defining a relationship between the input parameter value and a predetermined threshold value of the input parameter. The exemplary protection relay also includes means for dividing the determined at least one calculation parameter value into two or more zones, and restricting the at least one calculation parameter value with zone-specific dividers. In addition, the exemplary protection relay includes means for adding the restricted calculation parameter value to a cumulative sum of the calculation parameter, where the cumulative sum of the calculation parameter is usable in a calculation equation for determining at least one of an operate and reset condition of the protection relay.

An exemplary embodiment of the present disclosure provides a method of controlling a protection relay. The exemplary method includes measuring an input parameter value for the protection relay, and determining at least one calculation parameter value based on an inverse definite minimum time curve defining a relationship between the input parameter value and a predetermined threshold value of the input parameter. The exemplary method also includes dividing the determined at least one calculation parameter value into two or more zones and restricting the at least one calculation parameter value with zone-specific dividers. In addition, the exemplary method includes adding the restricted calculation parameter value to a cumulative sum of the calculation parameter, where the cumulative sum of the calculation parameter is usable in a calculation equation for determining at least one of an operate and reset condition of the protection relay.

An exemplary embodiment of the present disclosure provides a non-transitory computer-readable recording medium having a computer program recorded thereon that causes a processor of a computing device to carry out operations which include: measuring an input parameter value for the protection relay; determining at least one calculation parameter value based on an inverse definite minimum time curve defining a relationship between the input parameter value and a predetermined threshold value of the input parameter; dividing the determined at least one calculation parameter value into two or more zones and restricting the at least one calculation parameter value with zone-specific dividers; and adding the restricted calculation parameter value to a cumulative sum of the calculation parameter, where the cumulative sum of the calculation parameter is usable in a calculation equation for determining at least one of an operate and reset condition of the protection relay.

### BRIEF DESCRIPTION OF THE DRAWINGS

Additional refinements, advantages and features of the present disclosure are described in more detail below with reference to exemplary embodiments illustrated in the drawings, in which:

FIG. 1 shows inverse-time operation curves;

FIG. 2 shows an example of the operate-time as a function of the signal ratio, according to an exemplary embodiment of the present disclosure;

FIG. 3 shows an example of the LUT values as a function of the LUT indices, where values are directly proportional to a reciprocal of operate time, according to an exemplary embodiment of the present disclosure; and

FIG. 4 shows an intermediate result during LUT value calculation with different curve and the maximum integral sum component value than in FIGS. 2 and 3, according to an exemplary embodiment of the present disclosure; and

FIGS. 5, 6A and 6B show exemplary embodiments of a method according to the present disclosure; and

FIG. 7 shows an exemplary embodiment of an apparatus according to the present disclosure.

### DETAILED DESCRIPTION

Exemplary embodiments of the present disclosure provide a protective relay and a method of controlling a protective relay which eliminate the above disadvantages.

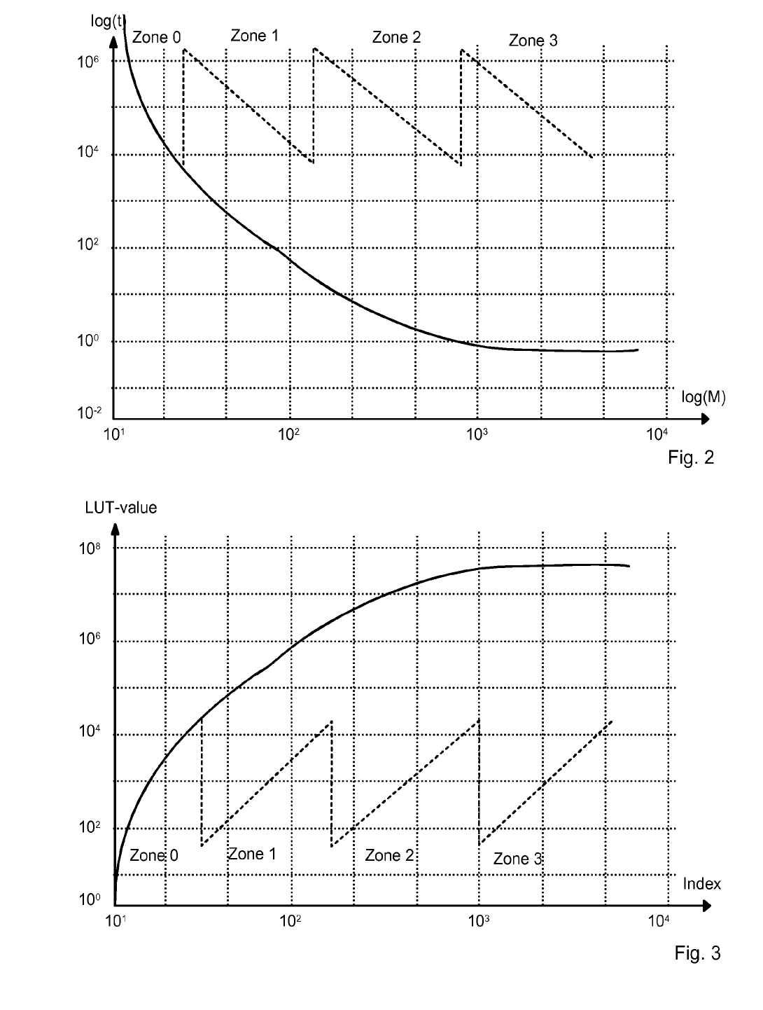

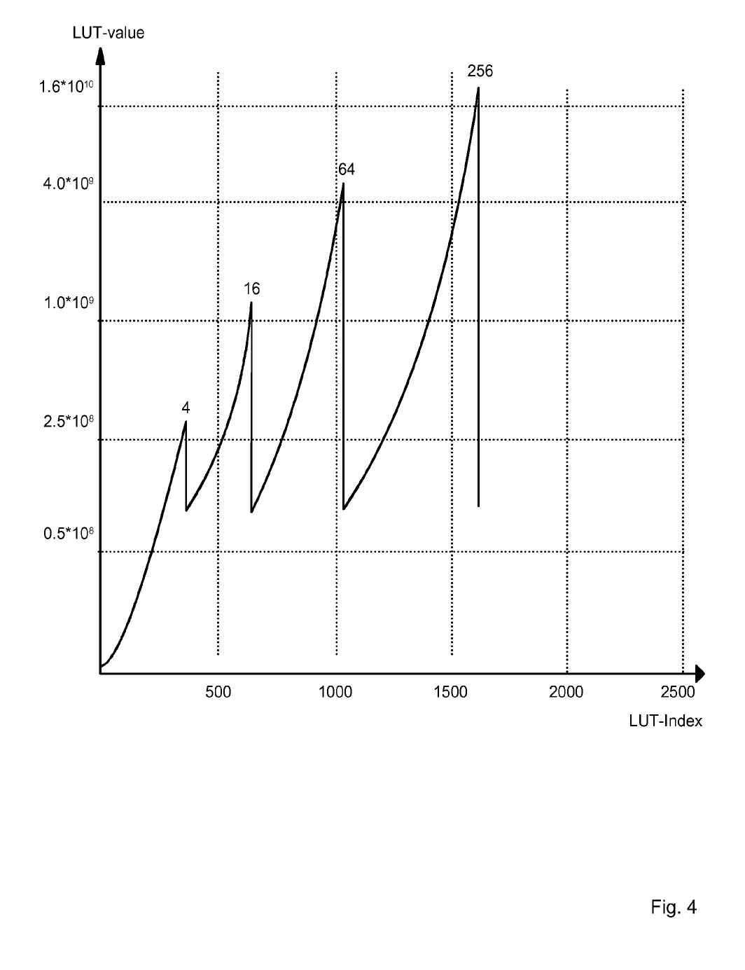

An exemplary embodiment of the method of the present disclosure is highlighted using FIGS. 2 and 3, which drawings principally present the same information.

In FIG. 2, the solid line represents operate-time information t(M), and the dashed line represents a restricted value.

FIG. 3 represents a modified reciprocal of the operate value, i.e., m/t(M), where m can be defined as an arbitrary fixed scaling factor, and the x axis has been given as a LUT index value with direct dependency on the signal ratio. Either of these drawings (FIG. 2 or 3) may represent the LUT content, but FIG. 3 is selected in the following. In accordance with another exemplary embodiment, instead of the LUT approach, the values can also be calculated during execution.

FIG. 3 shows that scaling can cause the LUT content value range to exceed far beyond reasonable limits for implementation (the largest value seen is 3.3959*10¹⁰ and log₂(3.3959*10¹⁰)≈34.98). While there is only a limited numeric range (bit length) for representing a calculation value, the LUT content information needs to be restricted to a threshold value. FIG. 3 shows an example where the highest possible LUT value has been restricted arbitrarily to 250,000. We define this value as the “maximum integral sum component value”, which limit value can be arbitrarily selected beforehand in implementation. After selecting the limit, the whole curve or original LUT content is evaluated for restricting all LUT values. This is done by continuously dividing all original LUT content values by a suitable value so that every LUT content value will be below the selected “maximum integral sum component value”. An exemplary result is shown as a dashed line in FIG. 3. When making these continuous divisions, so-called ‘zones’ that can be defined as ‘Zone 0’, ‘Zone 1’, etc., are found. Zone 0 values correspond to the original LUT content, while Zone 1 values represents the original LUT content divided by Q, Zone 2 values represent the original LUT content values divided by Q to the power of q, etc. The successive zone divisions will be Q⁰=1, Q^{q}, Q^{2q}, Q^{3q}, etc. Both Q and q can be arbitrarily selected, but powers of 2 are reasonable from the implementation point of view.

In FIG. 3, the example selection of Q and q are Q=2 and q=9. For user programmable curves, the curve evaluation can be done beforehand using a curve evaluation tool that can then also be used for downloading either curve parameters or alternatively the LUT content and zone changing indices to the relay. Alternatively, when a relay curve tool is not available, there can be an initialization script in relay that makes a curve evaluation and creates LUT content and zone indices during a relay cold or warm boot.

In FIG. 3, it can be seen that a non-restricted LUT value is mathematically a bijection (one signal ratio is mapped to one LUT value and vice versa), while a restricted LUT value function is a surjection (several signal ratio values produces the same LUT value). As already stated, when making successive divisions while evaluating the original LUT content, book-keeping can be performed for LUT content discontinuity indices that can later be used when finding and using the correct LUT value during execution. This is defined herein as an ‘index book-keeping’. In accordance with an exemplary embodiment, this indexing is more or less bounded to the LUT approach and, for pure calculation during execution, some other method with the same result can be selected.

By restricting the LUT values, multiplication overflow can be avoided when calculating operate-time during the execution phase with full control of multiplication terms. In accordance with an exemplary embodiment, the method of the present disclosure allows at least two alternatives to follow when selecting LUT step. First one is straightforward and already explained: the LUT values are restricted while keeping the same LUT step. However, in accordance with another exemplary embodiment, one can, after the LUT value restriction, scale the LUT content and by this way achieve an even tighter LUT grid by inserting new points to the operate-time curve between existing points. This is possible if the “maximum integral sum component value” has been chosen to have a value that can still be increased without multiplication overflow later during the execution. This could be visualized as curve stretching when studying FIG. 3.

The exemplary method of the present disclosure can be used for both floating and fixed-point solutions, but because this method lies on the pre-calculated (either from RAM memory or the calculation in the initialization phase) LUTs, it will be more powerful for cheaper fixed-point processors. Furthermore, exemplary embodiments described later specifically relate to situations, where parameter p is at least two, e.g., for steep operate curves. However, there may exist parameter selections with steep curves, where this method may also be found useful for value p=1.

Exemplary embodiments of the present disclosure advantageously provide that an arbitrary steep IDMT curve representation can be restricted by values so that operate-time accuracy requirements can be fulfilled even with limited word lengths.

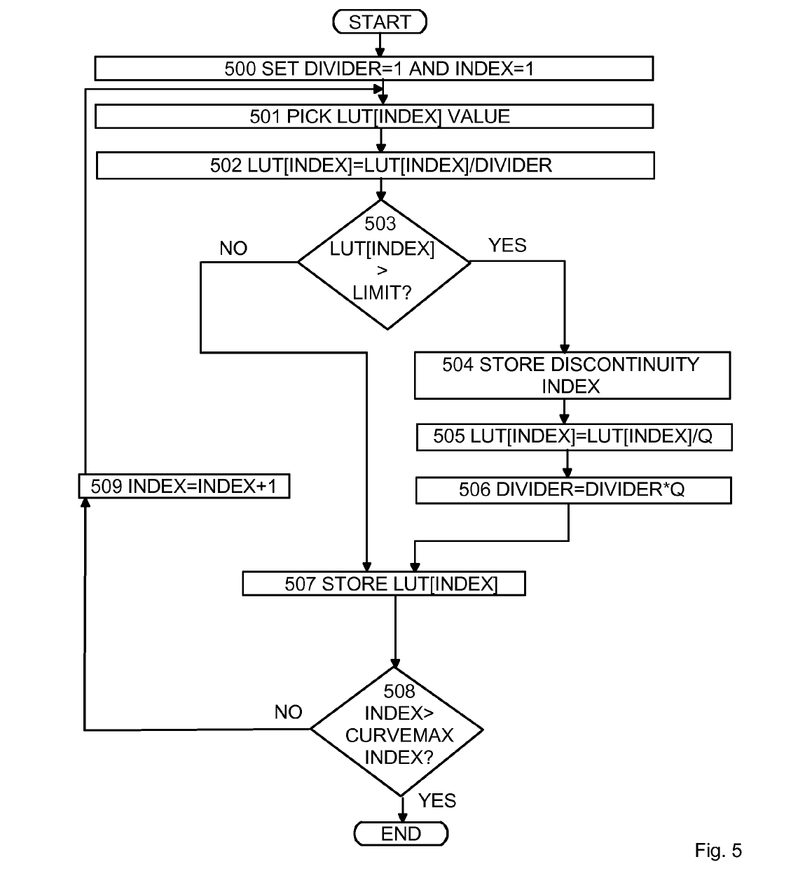

In accordance with an exemplary embodiment, a solution for the problems described above is the zone wise scaling of the original LUT values. The curve in FIG. 4 is a different curve from the curves in FIGS. 2 and 3. In the exemplary embodiment of FIG. 4, the limit value is higher than in FIGS. 2 and 3, where it was quite low due to illustration reasons. The curve in FIG. 4 uses linear scale and therefore appears different from the curves in FIGS. 2 and 3 using log-log scale.

FIG. 4 shows an exemplary embodiment of a lookup table (LUT) handling before restriction. The x axis depicts an index in the lookup table (which depends on the signal ratio), whereas the y axis depicts the value in the lookup table. In FIG. 4, the lookup table indices may be considered to have been divided into some successive zones. This may be done in a curve evaluation phase, for example. Evaluation can be done either beforehand in a special curve or using some other tool that results in that the new LUT content together with discontinuity indices are then written to a memory of the relay device (e.g., a non-transitory computer-readable recording medium of the relay device) or it can be created during relay initialization or even during the execution phase. Curve evaluation during execution is also possible. An advantage for doing curve evaluation beforehand is that it is easy to do in a floating-point format or by emulating floating-point arithmetics in the initialization (off-line) phase in fixed-point processors. In fact, some standards even require curve parameters to be defined as floating-point values.

FIG. 4 shows an example where successive zone (0, 1, 2, 3, 4) indices are 0 . . . 375, 376 . . . 672, 673 . . . 1054, 1055 . . . 1625, and 1626 . . . maxIndex. In accordance with this example, curve discontinuity indices are then 376, 673, 1055 and 1626, respectively. Each zone is provided with dividers, which are 4, 16, 64 and 256 respectively, where pre-selected divider Q=4 has been selected. The threshold value triggering a division of the table value, that is, the maximum integral sum component value, has been selected to be 2.5*10⁸ here. Both the pre-selected divider and the maximum integral sum component value can be arbitrarily selected. A new divider is taken into use when the table value for the first time exceeds the threshold value. That is, the divider “4” is used when the originally calculated LUT value for the first time exceeds 2.5*10⁸, which happens approximately at the LUT index of about 376. After that, the divider “4” is used while the LUT index exceeds 375 until it exceeds 672. All LUT indices are gone through in this ‘curve evaluation phase’. LUT values shown in FIG. 4 are given before corresponding value restriction. In the end, no LUT value can exceed the maximum integral sum component value.

By means of the divisions shown in FIG. 4, the lookup table values used in determining an operation condition, such as tripping, are kept low so as to avoid overflow in the calculation of the operating condition. Although FIG. 4 refers to “division”, division is computationally a heavy operation and in practice the operation may be bit-shifting, for example.

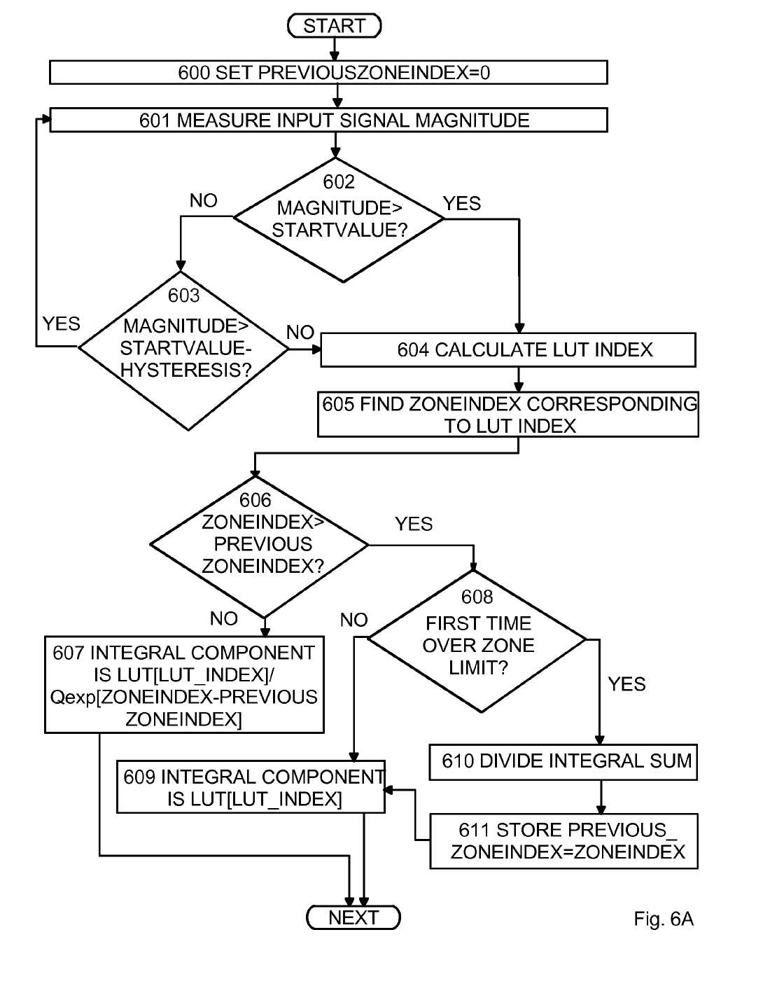

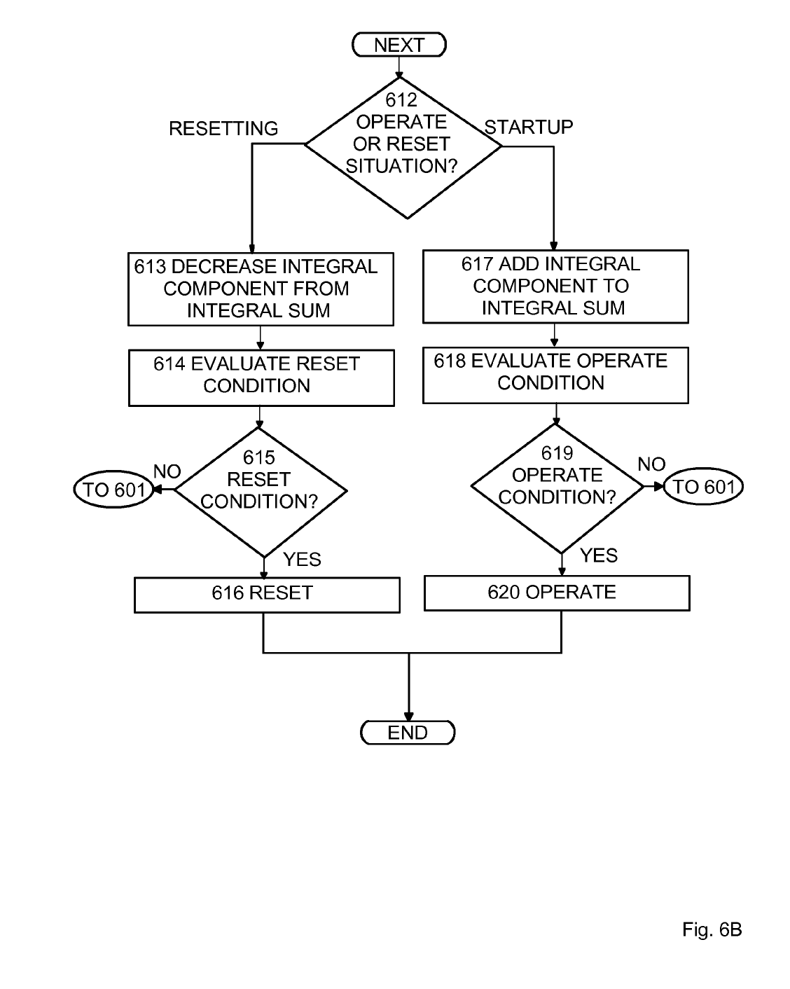

FIGS. 5 and 6 show an exemplary embodiment of a method according to the present disclosure.

The first part of the method represents an IDMT curve evaluation phase that can also be called an original LUT value restriction phase.

In the following, the maximum integral sum component value is called LIMIT, the maximum index of LUT table is called MAXINDEX, and the pre-selected divider step value, e.g., power of 2, is called Q, as noted above.

In step 500, both the original DIVIDER and LUT INDEX are set to a unity. Then, in step 501, the indexed original LUT value is picked for evaluation either by calculating it from the curve or fetching it from the already calculated value vector. Next, in step 502, this picked value is first divided by DIVIDER and in step 503 compared with LIMIT. If LIMIT is not exceeded, the already calculated LUT value remains at step 507. However, if the value exceeds LIMIT, then the corresponding INDEX is stored in step 504 for representing a curve discontinuity index in FIG. 4. It can also be remarked that the LUT values presented in FIG. 4 represent values at this moment before another division. In step 505, the picked LUT value is again divided (now by Q) and finally, in step 506, DIVIDER is updated by multiplying the existing value with this same Q (here it is assumed that q equals to a unity). In step 507, the modified LUT value is restored. After this step, it is checked in step 508 if INDEX equals MAXINDEX. If there are still LUT indices available then in step 509 INDEX is increased by a unity and the routine returns to step 501 until the whole original LUT content has been gone through.

The number of zones or discontinuity indices may be arbitrary, but are at least two. While the number of zones for curves that are predefined will be fixed during the off-line evaluation phase, a sufficient number of zones and especially the vector allocation length may need to be defined for calculating the arbitrary number of discontinuity indices of the user-defined curves if no dynamic allocation can be used during a warm boot.

The exemplary embodiment of FIG. 5 can take place “off-line”. An alternative to the off-line determination, in accordance with another exemplary embodiment of the present disclosure, provides an external application to the protective relay. The lookup table values and zone indices may be downloaded/inputted from the external application/device to the protective relay before the usage phase.

FIG. 6 shows another exemplary embodiment, which is carried out “on-line” in the execution phase. If curve/LUT evaluation is also run in the execution phase, then these two embodiments may be combined, but this is a rather straightforward operation to do if needed.

This exemplary embodiment explains how an operate action is derived during the execution phase using the LUT-values calculated off-line (FIG. 5). Description in the following is given concerning over-function operation but this embodiment is also easy to apply to under function. Furthermore, this exemplary embodiment can also be applied for reset (drop-off) action with corresponding modifications.

PREVIOUSZONEINDEX has been set to zero (e.g., default zone is always “Zone 0”) before startup in step 600. STARTUP is then TRUE but RESETTING equals FALSE indicating that START output has been activated and no reset/drop-off situation takes place. In step 601, the relay measures the input signal magnitude. The relay has a startup magnitude threshold level. When the magnitude exceeds the startup threshold (user preset value “Start value”, here defined as STARTVALUE), the relay is said to have started. After starting, the relay starts to calculate/cumulate the time to trip and in most implementations also the time to reset (drop-off) simultaneously, if this functionality is supported. At its simplest, the tripping condition occurs when the cumulated time exceeds the time calculated from Equation (1) or (2), if a constant signal is used. Otherwise, integration is more complex but the operating (tripping) time is always a function of typically varying successive input signal ratios. In step 602, the magnitude is compared with STARTVALUE. If the magnitude still exceeds STARTVALUE, then STARTUP remains TRUE. If the magnitude now undershoots STARTVALUE-HYSTERESIS in comparison step 603, RESETTING will become TRUE. Otherwise, the hysteresis condition is TRUE and the routine returns to step 601. In accordance with an exemplary embodiment, HYSTERESIS may be a factory defined parameter used for avoiding operating oscillation in the vicinity of STARTVALUE. It can also be set to zero. Independently of the STARTUP or RESETTING activation, the next step will otherwise be step 604 where LUTINDEX corresponding to the signal magnitude will be calculated. Then, in step 605, the ZONEINDEX corresponding to found LUTINDEX will be defined. Here ZONEINDEX is found by comparing the pre-calculated curve discontinuity index vector with LUTINDEX.

According to the comparison in steps 606/608, the exemplary method branches to steps 607, 609 or 610. If ZONEINDEX exceeds PREVIOUSZONEINDEX in step 606, then another decision on whether this is the first time when we enter this particular ZONEINDEX will be made in step 608. An example of four zones 0 to 3 may be considered. If the previous values have only been from the zones 0 and 1, a value exceeding the lower limit of zone 2 or 3 is considered to fulfill the condition in step 608. In accordance with an exemplary embodiment, if the previous values have been from zones 2 and 3 only, and the new values are from zone 0 or 1, this is not considered as entering a new zone but leads to step 607. This is due to the consideration that entering a zone also marks all zones below the zone in question as marked. Thus, entry into zone 1 is not considered as a new entry if there has been an entry in a higher zone. Effectively, in step 608, it is checked if a new zone higher than the zones used so far has been entered. If this is a first zone border overshoot [step 610], the cumulated integral sum will be modified to further integration by dividing it by a value. For example, we can use value Q to the power of (ZONEINDEX-PREVIOUSZONEINDEX) as a value here, while still assuming q to be a unity. In continuation, in step 611, PREVIOUSZONEINDEX will be replaced by ZONEINDEX.

The value stored in LUT[LUTINDEX] is used as such for a new integral component in step 609. If ZONEINDEX undershoots or is equal to PREVIOUSZONEINDEX in step 606, then the new integral component will be in step 607 LUT[LUTINDEX] divided by Q to the power of (ZONEINDEX-PREVIOUSZONEINDEX).

In these steps 607, 609 or 610, the new integral component is divided with a zone divider, which refers here to a zone-specific divider. In the case of four zones (0 . . . 3) and Q=4 and q=1, for example, the dividers may be 1, 4, 16 or 64. The divisions may be, in practice, carried out as bit-shift operations instead of actually calculating a division operation. In step 608, if the divider used so far is 16 (divider of zone 2), this divider is used if the current value of the LUT index belongs to the first or second zone. However, if the new value read from the lookup table enters a zone that is so high that has not been entered before, the method proceeds to steps 610 and 611, and a new divider is taken into use. For example, if the previous entries have only been to zones 0 and 1, and zone 2 is now entered, in step 610, the divider 4²=16 is taken into use and will be used subsequently for all entries of zones (groups) 0 to 2 until an entry into group 3 is made.

Now, after defining the new integral component, it is indicated again in step 612 whether the decision for step(s) 602/603 was STARTUP or RESETTING. Both cannot be TRUE simultaneously in this context even when the START output also remains active during RESETTING until the reset condition is later fulfilled. If the condition was RESETTING, then in step 613 the new integral component is decreased from the cumulated integral sum unless in the combined equation approach both timers are increased. Then, in step 614, the condition for the reset operation is first determined and if the reset condition is fulfilled, RESET takes place in step 616 and STARTUP is no longer TRUE. Otherwise, if the condition in step 612 was STARTUP, then in step 617 the new integral component is incremented to the cumulated integral sum. Then, in step 618, the condition for operate is first determined and if the operate condition is fulfilled in step 619, OPERATE (tripping) takes place in step 620. If the condition in step 615 or 619 is NO, then the routine returns to step 601.

The operate or reset (drop-off) condition is determined in steps 613 and 617, respectively. The operate or reset (drop-off) condition can be determined by implementing one 1/t-type integrator for both conditions and by making a division in every task cycle before integral sum accumulation like explained in the background information. However, this straightforward way is prone to errors due to division, as already explained in the background section.

In accordance with an exemplary embodiment, one way to avoid the above disadvantage and to implement this operate or reset (drop-off) condition effectively is to combine the operate and reset conditions with an equation that can be deduced from equations (1) or (2). In the following, it is shown how signal zone changes presented in the above embodiments can be taken into account when implementing the combined operate and reset condition in practice. Consequently, if no zone changes occur during startup of the protective relay, no weightings will be needed. Furthermore, a weighting approach can also be totally or partly omitted if the operate and reset calculations are done separately and only the divided values are combined with known implementation drawbacks. However, for these type of simpler implementations, there also exist a weighting equation that can be derived from this one to be presented in the continuation. Consequently, it is sufficient to describe here only the weighting equation concerning combined operate/reset equation case.

After some manipulation, the combined operate and reset condition may be written as equation (3). This equation presents a general form that is directly applied to the current equation given in the IEEE standard. It is to be noted that the equation depends heavily on which part of equation (1) or (2) is selected to be written into the LUT. Here, the equation (1) or (2) denominator has been selected to be written in the LUT. Other variations also exist but the problem solved later in the text remains the same, that is, to emphasize (weight) momentary integral sums when the zone is changed. Some scaling parameters for avoiding equation overflow can be inserted for fixed-point systems but their importance is not high for the exemplary method of the present disclosure. As a result, it is assumed here that equation terms do not flow over during multiplication.

$$startDuration = 100 \% * ( \frac{\begin{matrix}operCounter * sumOfS + timeShift * sumOfS - \\ decOFS * sumOfS * BperTR - decOfS * operCounter * AperTR\end{matrix}}{sumOfS * curveDelay + operCounter * curveMult} ) \qquad ( 3 )$$

Variable “startDuration” runs from 0 to 100%. The tripping condition occurs when the variable value becomes 100%, and the reset condition when the variable value is decreased to 0%, e.g., the nominator equals zero. In practice, the tripping condition can easily be determined from equation (3) by comparing the nominator and the denominator. If the nominator becomes equal to the denominator, the startDuration variable becomes 100%.

Variable operCounter denotes a cumulative index of the task time that is the number of operation cycles executed since the startup of the protective relay. Equation (3) is calculated once in an operation cycle, which may be 2.5 ms, for example. Effectively, this corresponds to the operation in the relay during one operation cycle. There are a number of fixed parameters used in equation (3) but these are not very significant for the present embodiment. Only the general form of equation is important here in this context. Parameter timeShift compensates for the system delay in starting the operation of the relay from an order to do so. Parameter curveDelay refers to k*b/taskTime, where k and b refer to parameters defined in equation (1) or (2), and taskTime is the duration of an operation cycle. CurveMult refers to k*a/taskTime. AperTR refers to curveMult/resetMult, and BperTR refers to curveDelay/resetMult, in which substitution resetMult refers to k*tr/taskTime. Here, tr refers to the reset equation parameter given in IEEE standard. In accordance with an exemplary embodiment, these are all fixed values during execution.

Variable sumOfS is a cumulative variable. In the context of the present disclosure, it is called an “integral sum”. The sum calculation parameter is a sum of “new integral components” calculated in each operation cycle. SumOfS effectively corresponds to a sum of the new integral components in equation (2). The values of the temporary calculation parameter may be stored beforehand in a lookup table. Parameter decOfS refers to a variable similar to sumOfS, but which is used for reset purposes. The cumulated integral sum presented in exemplary embodiments of the present disclosure effectively combines both sumOfS and decOfS here.

Equation (3) shows an exemplary embodiment of the calculation equation that is used in steps 614 and 618 according to the present disclosure. Another embodiment that allows control of cumulated sums when zone changes take place is shown in equation (4):

$$startDuration = 100 \% * ( \frac{\begin{matrix}operCounter * sumOfS + timeShift * sumOfS - \\ decOFS * sumOfS * BperTR - decOfS * \\ fixOperCounter * AperTR * 1 / S 1 - decOfs * \\ ( operCounter - fixOperCounter ) * AperTR * 1 / S 2\end{matrix}}{\begin{matrix}sumOfS * curveDelay + fixOperCounter * curveMult * \\ 1 / S 1 + ( operCounter - fixOperCounter ) * curveMult * 1 / S 2\end{matrix}} ) \qquad ( 4 )$$

Equation (4) introduces multipliers S1 and S2, which are provided to tune the accuracy of the equation when the zone changes. A weighting matrix is provided for this purpose, which weighting matrix takes into account the previous zone and the current/new zone and gives the weighting value of the old and current cumulative sums (note the subtraction between operCounters in the equation). When comparing equations (3) and (4), it can be seen that this modification has been done due to the operCounter parameter, because it is effectively used for multiplying the cumulated sums. The equation given in (4) shows only the simplest form of the zone change philosophy. Here, it is for the sake of simplicity that only one zone change upwards takes place (e.g., signal ratio increases once beyond the curve discontinuity limit) and this is why there is in equation (4) just operCounter for the current zone and fixOperCounter for the previous zone weighting purposes. It is easy to implement more complex cases with an unlimited number of zone changes where all these variations insert another parameter fixOperCounter2, fixOperCounter3, etc. As a result, operCounter represents a counter that is still increased during STARTUP, while fixOperCounter represents a frozen value from the moment when a zone change took place.

A simple example of a weighting matrix is shown in Table 1. These weighting factors can be given beforehand, but it is also possible to estimate a weighting factor during execution, if desired. Note that here Q=2, q=1, and all S1/S2 are powers of Q. This effectively presents divisions in equation (4) to be just bit-shifts.

TABLE 1
Weighting matrix

| S1/S2 | 0(current zone) | 1 | 2 |
|---|---|---|---|
| 0 (previous zone) | 1/1 | 4/1 | 8/2 |
| 1 | 1/4 | 4/4 | 16/8 |
| 2 | 4/8 | 16/16 | 16/16 |

For example, when the zone changes from 1 to 2, S1 gets the value 2⁴=16, and S2 gets the value 2³=8. If the zone changes from 2 to 0, S1 gets the value 2²=4 and S2 gets the value 2³=8. If a fixed weighting matrix is used, it should have as many rows as there are possible zones. This is important for user programmable curves where there can be an unknown number of zones. It is also rather straightforward to present a generalized matrix for use.

Old and current integral sums accumulated during a signal that stays in different zones have to be somehow weighted during execution and there always exists a weighting matrix that can be used for this purpose. As a result, equation (4) can be generalized so that it is possible to have a finite number of S parameters and corresponding operCounter values where all but one are simultaneously frozen during execution and the complete implementation of these S parameters and corresponding operCounter values gives unlimited accuracy for calculating the operate-time. In practice, however, it is reasonable to restrict the number of S parameters and corresponding operCounter values just to a few.

In step 618, the operate condition is determined. Referring to equation (4), this corresponds to determining if the startDuration value reaches 100%. To calculate the startDuration, other parameters in equation (4) need to be calculated, as well.

In step 619, the calculated operate condition is estimated. Referring to equation (4), it is checked if startDuration has reached 100%. If so, the method proceeds to step 620, where the tripping condition is considered as fulfilled. If not, the method returns to step 601 to measure the input voltage in the next operation cycle.

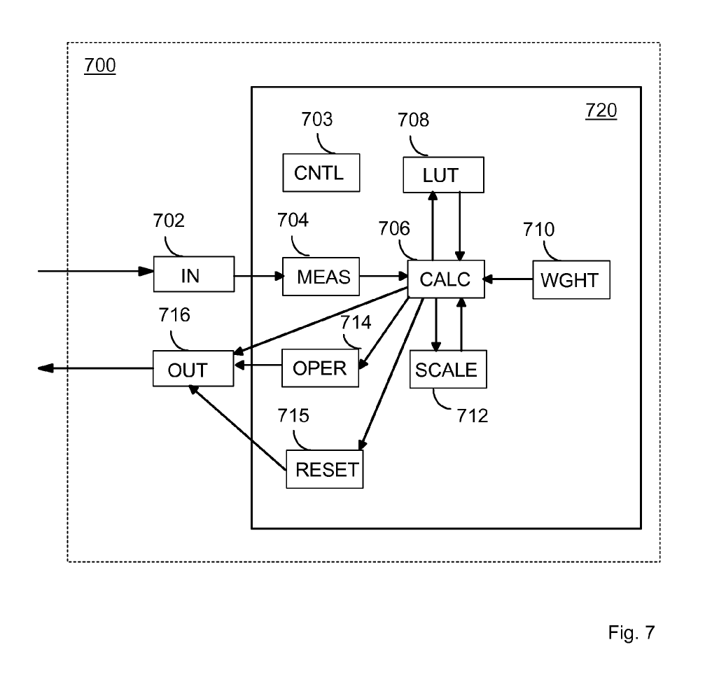

FIG. 7 shows an exemplary embodiment of an apparatus 700. The apparatus may be an over voltage, under voltage, over current, or under current relay, for instance, or may be function on the basis of frequency, temperature, power, energy, pressure or some derivates of these values. The relay 700 includes a fixed-point or a floating point processor 720, that is, a processor applying fixed/floating-point arithmetic. In accordance with an exemplary embodiment, the processor 720 can be a general-purpose processor configured to execute a computer program tangibly recorded on a non-transitory computer-readable recording medium, e.g., a ROM, hard disk drive, optical memory, flash memory, etc. In this case, the general-purpose processor can be configured to carry out the operative functions described herein by executing the computer program recorded on the non-transitory computer-readable recording medium. In accordance with an exemplary embodiment, the processor 720 can be an application specific processor that is specifically configured to carry out the operative functions described herein. The non-transitory computer-readable recording medium can be a memory resident in the protective relay 700 and/or communicatively connected to the protective relay 700. The operative functions of the processor are described below with reference to the block diagram of FIG. 7. It is to be understood that these components in the block diagram of FIG. 7 respectively correspond to various “means” components in accordance with the exemplary embodiments of the present disclosure as described herein.

The relay includes an input port 702 for inputting an input measure, such as current, voltage or frequency. The relay also includes an output port 716 for outputting a control signal such as a control signal for cutting the electricity feed in the event of fulfillment of the tripping condition in the relay 700. The output port 716 can also be configured to indicate STARTUP for external needs.

The processor 720 includes a control unit 703 for controlling and coordinating the operation of the processor. A function reporting cycle may be 2.5 ms, for example. The processor 720 further includes a measuring unit 704 for measuring the input signal, performing an analog-to-digital conversion and determining the level of the input signal. The processor 720 further includes a calculating unit 706 for calculating a relation of the input measure to a predetermined threshold level of the input measure. Calculating unit 706 can be configured to give a STARTUP indication to output port 716 if this threshold level is exceeded. On the basis of comparison between a calculated signal ratio, the calculating unit 706 derives a lookup table index. There is a predetermined lookup table (LUT) 708 that hosts pre-calculated threshold restricted values that result from the curve evaluation phase. As another result from this curve evaluation phase predetermined zone indices have also been stored to a scaling unit 712. A third unit that could have been stored beforehand is a weighting matrix unit 710. Alternatively, all or some of these unit results (708, 710, 712) can be calculated during initialization or execution in the calculating unit 706.

The calculating unit 706 reads the lookup table value corresponding to the derived lookup table index from the table 708 and delivers it to the scaling unit 712. The scaling unit 712 determines which zone the lookup table value belongs to and how much it should be scaled based on the difference between the previous and current zones. The scaling unit 712 also scales the already cumulated integral sum for the calculating unit 706 if needed. Furthermore, the weighting unit 710 can be used to control weights of the old and new cumulative operating sum parts within the operate-time calculation when and if zone changes take place.

The operate unit 714 determines if the operate/tripping condition has occurred. In this determination, the operate unit 714 may calculate the operands of equation (4) or some other equation, and determine if the operate condition is met. If the operate condition is met, the output unit 716 provides a control signal (OPERATE/TRIP will be activated). Similarly, the reset unit 715 determines if the reset/drop-off condition has occurred using the same equation (4) but different criteria. If the reset condition is met, the output unit 716 will be provided by a STARTUP deactivation indication (START-output will be deactivated).

The units on the processor 720 may be implemented by means of one or more hardware components executing a compute program, as described above. For example, as noted above, an exemplary embodiment of the present disclosure provides a non-transitory computer-readable recording medium having a computer program recorded thereon that causes the processor 720 of the relay 700 to carry out any of the operative features described herein.

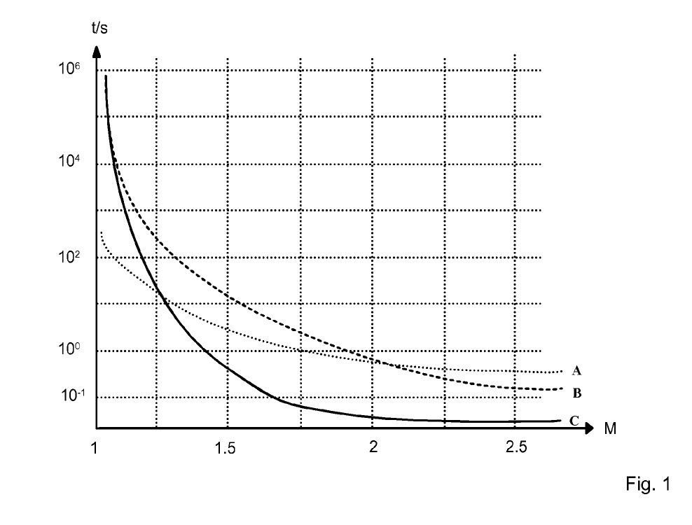

By way of the disclosed embodiments, the implementation is made feasible in a fixed-point environment. The embodiments provide that calculation overflows can effectively be reduced. The embodiments are especially effective in situations where the calculation curves depicted in FIG. 1 are extremely steep mainly due to exponent values 2 or higher. If user-defined curves are provided for, the exponents in the denominator may get an arbitrarily high value, which has a direct influence to the steepness of the curve.

It will be obvious to a person skilled in the art that, as the technology advances, the inventive concept can be implemented in various ways. The disclosure and its embodiments are not limited to the examples described above but may vary within the scope of the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A protection relay, comprising:
means for measuring an input parameter value for the protection relay;
means for determining at least one calculation parameter value based on an inverse definite minimum time curve defining a relationship between the input parameter value and a predetermined threshold value of the input parameter;
means for dividing the determined at least one calculation parameter value into two or more zones, and restricting the at least one calculation parameter value with zone-specific dividers; and
means for adding the restricted calculation parameter value to a cumulative sum of the calculation parameter, the cumulative sum of the calculation parameter being usable in a calculation equation for determining at least one of an operate and reset condition of the protection relay.

2. The protection relay according to claim 1, comprising:
means for storing the determined at least one calculation parameter value in a lookup table such that each lookup table value is referable with a lookup table index.

3. The protection relay according to claim 2, comprising:
means for inputting zone change indices and restricted calculation parameter values into the lookup table from an external tool.

4. The protection relay according to claim 2, comprising:
means for determining the at least one calculation parameter value of an inverse definite minimum time curve off-line index-specifically before startup of the protection relay, wherein the means for off-line determination comprises for each index:
means for comparing the calculation parameter value corresponding to the index with a predetermined threshold value of the calculation parameter;
means for storing the index as a zone change index when the calculation parameter value corresponding to the index exceeds the predetermined threshold value;
means for dividing the calculation parameter value with a zone-specific divider when the calculation parameter value corresponding to the index exceeds the predetermined threshold value;
means for storing the divided calculation parameter value in the lookup table; and
means for determining the zones of the calculation parameter on the basis of one or more discontinuity indices.

5. The protection relay according to claim 1, comprising:
means for weighting, in a zone change situation, the calculation parameter and the cumulative sum of the calculation parameter with one or more zone change multipliers dependent of the previous zone and the current zone.

6. The protection relay according to claim 1, comprising:
means for dividing the calculation parameter value in a zone with a divisor of the zone when an index pointing to the calculation parameter value for the first time falls into the zone and has not had, after startup of the protection relay, values greater than those in the zone; and
means for applying the divider of the zone during the startup of the protection relay to dividing of calculation parameter values belonging to the zone and possible lower zones until the calculation parameter value falls into a higher zone having higher index values than the zone, whereupon the calculation parameter values belonging to the higher zone and zones lower than the higher zone are divided with the divider of the higher zone.

7. The protection relay according to claim 1, comprising:
means for determining the operate condition on the basis of a calculation equation including:
$$t ( M ) = \frac{k * a}{{( b * \pm ( \frac{M}{M ≺} - e ) - c )}^{p} - f} + d ,$$
where
t is the operate (trip)-time in seconds,
k is a settable time multiplier,
M is a measured magnitude,
M< is a settable start magnitude
a, b, c, d, e, f, p are settable curve parameters.

8. The protection relay according to claim 1, wherein the input parameter is one of voltage, current, frequency, temperature, pressure, and a derivation thereof.

9. The protection relay according to claim 1, wherein the protection relay comprises a fixed point processor, and means for restricting the at least one calculation parameter value such that the at least one calculation parameter value stays below a bit limit of the fixed point processor.

10. The protection relay according to claim 1, comprising:
means for restricting the at least one calculation parameter value; and
means for determining the zone change indices online during execution.

11. A method of controlling a protection relay, comprising:
measuring an input parameter value for the protection relay;
determining at least one calculation parameter value based on an inverse definite minimum time curve defining a relationship between the input parameter value and a predetermined threshold value of the input parameter;
dividing the determined at least one calculation parameter value into two or more zones and restricting the at least one calculation parameter value with zone-specific dividers; and
adding the restricted calculation parameter value to a cumulative sum of the calculation parameter, the cumulative sum of the calculation parameter being usable in a calculation equation for determining at least one of an operate and reset condition of the protection relay.

12. The method according to claim 11, comprising:
determining the at least one calculation parameter value of an inverse definite minimum time curve off-line index-specifically before startup of the protection relay, wherein the off-line determination comprises for each index:
comparing the calculation parameter value corresponding to the index with a predetermined threshold value of the calculation parameter;
storing the index as a discontinuity index when the calculation parameter value corresponding to the index exceeds the predetermined threshold value;
dividing the calculation parameter value with the zone-specific divider when the calculation parameter value corresponding to the index exceeds the predetermined threshold value;
storing the divided calculation parameter value in a lookup table; and
determining the zones of the calculation parameter on the basis of one or more discontinuity indices.

13. The method according to claim 11, comprising:
dividing the calculation parameter value in a zone with a divisor of the zone when an index pointing to the calculation parameter value for the first time falls into the zone and has not had, after startup of the protection relay, values greater than those in the zone; and
applying the divider of the zone during the startup of the protection relay to dividing of calculation parameter values belonging to the zone and possible lower zones until the calculation parameter value falls into a higher zone having higher index values than the zone, whereupon the calculation parameter values belonging to the higher zone and zones lower than the higher zone are divided with the divider of the higher zone.

14. The method according to claim 11, wherein the calculation equation for determining the operate condition includes:
$$t ( M ) = \frac{k * a}{{( b * \pm ( \frac{M}{M ≺} - e ) - c )}^{p} - f} + d ,$$
where
t is the operate (trip)-time in seconds,
k is a settable time multiplier,
M is a measured magnitude,
M< is a settable start magnitude, and
a, b, c, d, e, f, p are settable curve parameters.

15. A non-transitory computer-readable recording medium having a computer program recorded thereon that causes a processor of a computing device to carry out operations comprising:
measuring an input parameter value for the protection relay;
determining at least one calculation parameter value based on an inverse definite minimum time curve defining a relationship between the input parameter value and a predetermined threshold value of the input parameter;
dividing the determined at least one calculation parameter value into two or more zones and restricting the at least one calculation parameter value with zone-specific dividers; and
adding the restricted calculation parameter value to a cumulative sum of the calculation parameter, the cumulative sum of the calculation parameter being usable in a calculation equation for determining at least one of an operate and reset condition of the protection relay.

16. The non-transitory computer-readable recording medium according to claim 15, wherein the program causes the processor to perform further operations comprising:
determining at least one calculation parameter value of an inverse definite minimum time curve are determined off-line index-specifically before the startup of the protection relay, wherein the off-line determination comprises for each index:
comparing the calculation parameter value corresponding to the index with a predetermined threshold value of the calculation parameter;
storing the index as a discontinuity index when the calculation parameter value corresponding to the index exceeds the predetermined threshold value;
dividing the calculation parameter value with the zone-specific divider when the calculation parameter value corresponding to the index exceeds the predetermined threshold value;
storing the divided calculation parameter value in a lookup table; and
determining the zones of the calculation parameter on the basis of one or more discontinuity indices.

17. The non-transitory computer-readable recording medium according to claim 15, wherein the program causes the processor to perform further operations comprising:
dividing the calculation parameter value in a zone with a divisor of the zone when an index pointing to the calculation parameter value for the first time falls into the zone and has not had, after startup of the protection relay, values greater than those in the zone; and
applying the divider of the zone during the startup of the protection relay to dividing of calculation parameter values belonging to the zone and possible lower zones until the calculation parameter value falls into a higher zone having higher index values than the zone, whereupon the calculation parameter values belonging to the higher zone and zones lower than the higher zone are divided with the divider of the higher zone.

18. The non-transitory computer-readable recording medium according to claim 15, wherein the calculation equation for determining the operate condition includes:
$$t ( M ) = \frac{k * a}{{( b * \pm ( \frac{M}{M ≺} - e ) - c )}^{p} - f} + d ,$$
where
t is the operate (trip)-time in seconds,
k is a settable time multiplier,
M is a measured magnitude,
M< is a settable start magnitude, and
a, b, c, d, e, f, p are settable curve parameters.
